(19) United States
(12) Patent Application Publication
(10) Pub. No.: US 2015/0021808 A1
(43) Pub. Date: Jan. 22, 2015

(54) DIE AND PROCESS FOR STRAND PELLETIZING A POLYMER COMPOSITION

(71) Applicant: DSM IP ASSETS B.V., Heerlen (NL)

(72) Inventor: Guido Richard Struijk, Echt (NL)

(73) Assignee: DSM IP ASSETS B.V., Heerlen (NL)

(21) Appl. No.: 14/378,492

(22) PCT Filed: Feb. 13, 2013
(86) PCT No.: PCT/EP2013/052865

§ 371 Date: Aug. 13, 2014

(30) Foreign Application Priority Data
Feb. 14, 2012 (EP) 12155314.3

(51) Int. Cl. B29C 47/12; B29C 47/00

(52) U.S. Cl. CPC B29C 47/12; B29C 47/0011; B29K 2079/00
USPC 264/148; 425/461

(57) ABSTRACT

Die (1) for strand pelletizing a polymer composition, wherein the die surface (4) adjacent to the outflow opening (2) of the die is coated with a ceramic coating (5) or a polytetrafluorethylene containing coating.

The invention relates to a die for strand pelletizing a polymer composition and a process for strand pelletizing the polymer composition using the die.

Dies for strand pelletizing polymer compositions and processes using the die are generally known. Polymer compositions are fed to an extruder, molten in the extruder, put under pressure by the extruder screw and forced through the flow channel of a die that is mounted at the outlet of the extruder. In this way often a multiple of strands are formed that are cooled while running through a water bath and are after cooling fed to a cutter to be pelletized.

A problem when forming the strands of a polymer composition is the occurrence of building up or dripping of the composition at the outlet openings of the die of the extruder, also referred to as “die drool”. Die drool causes a variety of problems, such as process disruption and product failure. In JP-04235015-A a die for strand pelletizing is proposed comprising a ceramic layer at the inside wall of the die, forming the flow channel of the die. Such a die shows only a somewhat decreased occurrence of die drool. Furthermore the application of the ceramic coating at the inside of the die, especially if the flow channel is narrow, is difficult or even impossible. The coating is also subject to wear caused by the melt flow, especially if glass fiber filled polymer compositions are processed.

Object of the invention is to provide a die for strand pelletizing that shows no or at least a decreased occurrence of die drool when processing a polymer composition.

Surprisingly this object is obtained if the die surface adjacent to the one or more outflow openings of the die is coated with a ceramic coating or a polytetrafluorethylene (PTFE) containing coating. It is surprising that the positive influence on die drool is obtained if the surface is coated, that in principle is not part of the flow channel of the die, but adjacent to the outflow openings at the outside of the die. A further advantage is that the coating is not subject to wear caused by the melt flow. The occurrence of die drool is especially a problem for a die for strand pelletizing. This is because such dies are often used for large scale production, during longer periods of continuous processing. In such processes the occurrence of die drool is especially problematic.

From U.S. Pat. No. 4,167,386 a die for pelletizing is known comprising a ceramic layer. However this is not a die for strand pelletizing. Directly at the die a knife is mounted, that periodically wipes across the discharge face of the die, the wiping action resulting in cutting the extruded strands into the pellets that are cooled after being formed in this way. Such a pelletizer is also indicated with die pelletizer. The wiping or cutting action of the knife across the discharge face of the die causes the discharge face to wear rapidly. To overcome this excessive wearing it is common to provide the discharge face of the die with a hard layer, such as a ceramic layer. Also for this reason polymer compositions are often strand granulated, as in this process no knife runs across the discharge face of the die, but the strands are fed to a cutter, far remote form the die.

Preferably the ceramic coating or the polytetrafluorethylene containing coating has a contact angle, measured at 20° C. at a droplet of between 5 and 10 micro liter of distilled water, 30 sec. after the application of the droplet at the dry coating (advancing method), of at least 80°, more preferably at least 85°, even more preferably at least 90°, even more preferably at least 95°. Preferably as polytetrafluorethylene containing coating, a metal coating comprising polytetrafluorethylene particles is used. More preferably a ceramic coating is used, since such a coating has good durability. A ceramic coating is a coating of a ceramic material. Ceramic coatings may for example be applied by plasma spraying, dip-coating, electrophoretic deposition, chemical vapor deposition, physical vapor deposition and sol-gel coating. Good results are obtained if a coating comprising silica particles is used. Examples of such coatings are described in US 2008/0017074 and US2011/278283. Such coatings are for example on the market under the trade name Thermolon®, delivered by the Thermolon Group of Korea.

The thickness of the ceramic coating or the polytetrafluorethylene containing coating may be between 10 and 100 microns. Preferably the thickness of the coating is between 15 and 70 microns, more preferably between 20 and 50 microns.

The invention is especially suitable if the die contains a surface adjacent to the outflow opening that is perpendicular to the axis of the flow channel at the outflow opening. This is because for such dies the problems of die drool are large while a die according to the invention does not show or hardly shows the problem of die drool.

The die for strand pelletizing may comprise at least two outflow openings for strands, preferably at least 10, more preferably at least 20. The maximum amount of outflow openings is in principle not restricted, however a practical upper limit is 300, preferably 200, more preferably 150. The diameter of the outflow opening may vary between 1 and 6 mm, preferably between 2 and 5 mm, more preferably between 3 and 4 mm.

The material used for the construction of the die may be one of the normal materials for this purpose, for example steel according to DIN 1.1422.

The invention also relates to a process for strand pelletizing a polymer composition using a die according to the invention. Good results are obtained if a multi-phase polymer composition is used in the process according to the invention. This is because with multi-phase polymer compositions die drool often takes place, while it is effectively reduced by the die according to the invention. Examples of multi-phase polymer compositions include an inhomogeneous blend of two or more polymers or an inhomogeneous composition comprising a first polymer phase and a second phase of a low viscous component, for example an external lubricant or a mould release agent. Especially good results have been obtained if the shear viscosity at 1 s⁻¹ between the two phases is more than a factor of 3, preferably more than a factor of 5 as measured under processing conditions. Another example of a multi-phase polymer composition is a composition comprising one or solid additives, for example fillers, like talcum, flame retardants, reinforcing fibers like glass fibers, pigments etc.

The polymer composition used in the process according to the invention may comprise any thermoplastic polymer, such as for example polyethylene, polypropylene, polyesters, thermoplastic copolyester elastomers, nylons etc.

Preferably the thermoplastic composition is glass fiber reinforced nylon. This is because strand pelletizing is a process commonly used for the production of pellets of such a polymer composition and the problems of die drool are large with the known process.

The invention is further explained by the Figures, without being restricted thereto.

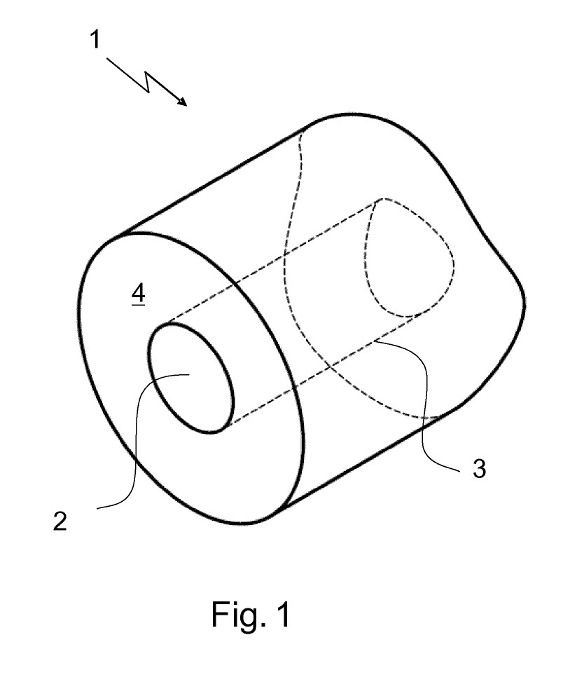

FIG. 1 is part of a die for strand pelletizing according to the state of the art with one outflow opening, not containing a coating at the surface adjacent to the outflow opening.

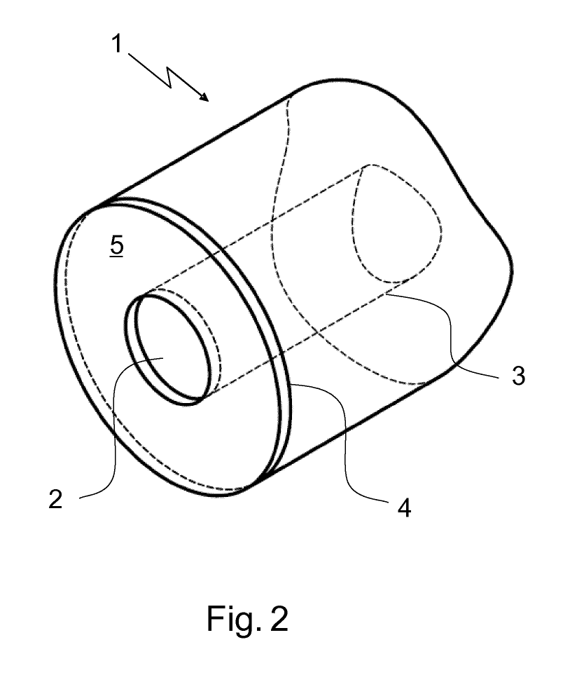

FIG. 2 is the die according to FIG. 1, however containing a coating at the surface adjacent to the outflow opening.

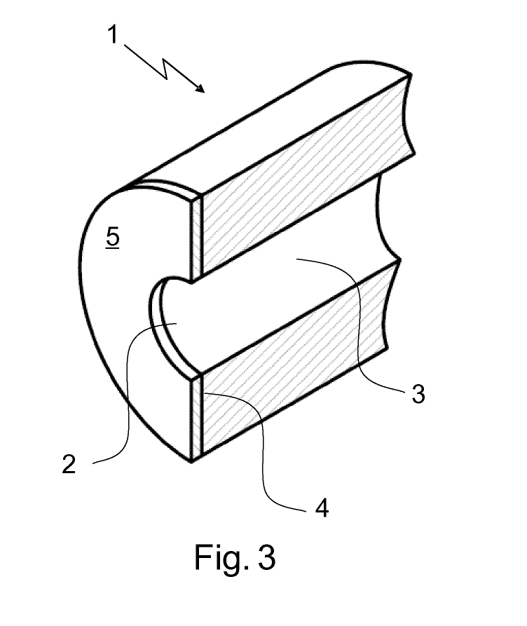

FIG. 3 is an intersection of the die of FIG. 2,

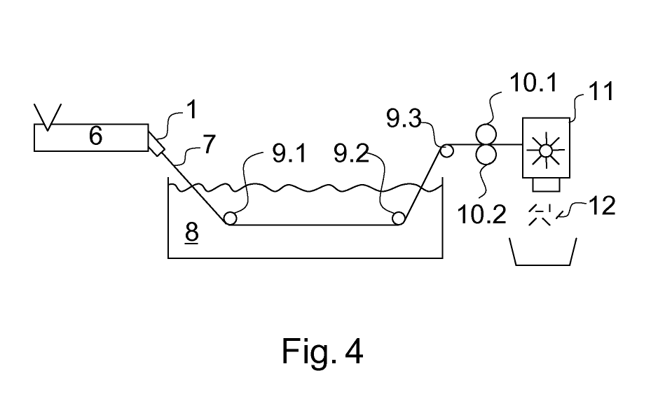

FIG. 4 is a schematic representation of an installation for the process according to the invention for strand pelletizing of a polymer composition.

FIG. 1 part of a die (1) for strand granulation, according to the state of the art invention, is shown. The die contains an outflow opening (2) of a die channel (3). The surface adjacent to the outflow opening (4) has not yet been coated.

FIG. 2 shows the die of FIG. 1, however the die according to the invention (1) contains a coating (5) at the surface (4) adjacent to the outflow opening (2). It is most appropriate to apply the coating to the entire surface (4), although it is also possible to coat the surface only immediately around the outflow opening.

FIG. 3 is an intersection of the die according to FIG. 2. Shown is the die (1), containing an outflow opening (2) of the flow channel (3). The surface (4) adjacent to the outflow opening (2) has been coated with the coating (5).

In FIG. 4 a schematic representation is given of an installation comprising an extruder (6), at which extruder the die for strand pelletizing (1) of FIG. 1 has been mounted. Only one strand (7) is shown in FIG. 2, which runs through a water bath (8), guided by rolls (9.1, 9.2 and 9.3 and transported by two rolls (10.1 and 10.2) into a cutter (11) for pelletizing the strand (7) into pellets (12).

The invention is further explained in the examples, without being restricted thereto.

### Measurement of Contact Angle

A droplet of 5 micro liter of distilled water was applied at the dry surface of the ThermoIon™ coating at 20° C. After 30 seconds a photo was taken of the droplet using standard equipment and the contact angle of the water droplet at the coating surface was determined form the photo. The contact angle was 96.6°.

### Example I

### Comparative Experiment A

For example I and comparative experiment A two of the same dies were used with one flow channel of a circular cross section, diameter 3 mm. One die has been coated with a Thermolon® coating at the surface adjacent to the outflow opening (example I), as indicated in FIG. 1. The other die was uncoated.

The dies were mounted at a single screw extruder with a screw diameter of 30 mm. A polymer composition of nylon 6 and 2 wt. % of talcum was processed through the die into a strand with an output of 5 kg/hour. The melt temperature of the polymer composition at the outflow opening was 280° C. The strand was pelletized by cutting the strand into pellets of a length of 3 mm. For the uncoated die (comparative experiment A) after less than a minute die drool was observed. Around the outflow opening a ring of polymer composition accumulated and burned into black material that occasionally sticks to the surface of strand and is ruptured from the die. After rupture of the burned material from the die new build up of material started. Some of the pellets showed black spots at their surface, originating from the burned material.

With the die according to the invention (Example I) no die drool was observed at all during the test period of one hour.

1. Die for strand pelletizing a polymer composition, characterized in that the die surface adjacent to the outflow opening of the die is coated with a ceramic coating or a polytetrafluorethylene containing coating.

2. Die according to claim 1, characterized in that the ceramic coating or the polytetrafluorethylenee containing coating has a contact angle, measured at 20° C., at a droplet of between 5 and 10 micro liter of distilled water, 30 sec. after the application of the droplet at the dry coating, of at least 80°.

3. Die according to claim 2, wherein the coating has a contact angle of at least 85°.

4. Die according to claim 1, wherein the coating comprises silica particles.

5. Process for strand pelletizing a polymer composition using a die according to claim 1.

6. Process according to claim 5, wherein the polymer composition is a multi-phase composition.

7. Process according to claim 6, wherein the composition contains a solid additive.

8. Process according to claim 7, wherein the polymer composition is a glass fiber reinforced nylon.
